(19) United States
(12) Patent Application Publication
(10) Pub. No.: US 2026/0120134 A1
(43) Pub. Date: Apr. 30, 2026

(54) METHOD FOR COORDINATED OPTIMIZATION OF WATER RESOURCES, ECOLOGICAL ENVIRONMENT, AND SOCIOECONOMIC SYSTEM IN WATER NETWORK SYSTEM

(71) Applicant: MWR GENERAL INSTITUTE OF WATER RESOURCES AND HYDROPOWER PLANNING AND DESIGN, Beijing (CN)

(72) Inventors: Xuning GUO, Beijing (CN); Yuanyuan LI, Beijing (CN); Weifeng LIU, Beijing (CN); Yunling LI, Beijing (CN); Feilin ZHU, Beijing (CN); Shaoming PENG, Beijing (CN); Yongqiang WANG, Beijing (CN); Qiubo SONG, Beijing (CN); Xigang XING, Beijing (CN); Xin WANG, Beijing (CN)

(21) Appl. No.: 19/311,056

(22) Filed: Aug. 27, 2025

(30) Foreign Application Priority Data
Oct. 24, 2024 (CN) 202411487681.9

(51) Int. Cl. G06Q 30/0202; G06Q 50/06

(52) U.S. Cl. CPC G06Q 30/0202; G06Q 50/06

(57) ABSTRACT

A method for water resources-ecological environment-economic society coordination in a water network system are provided. The method includes: fitting marginal distributions of rainfall and evapotranspiration, constructing a joint distribution, randomly sampling to obtain massive scenarios and inputting into a pre-built machine learning model to obtain water resources quantities; collecting historical population and historical gross domestic product (GDP) data of the study area, constructing an economic society scale prediction model, and constructing economic society scale prediction samples; constructing a multi-objective optimization model, calculating water resources-ecological environment-economic society coordination indicators, constructing a system dynamics model and calibrating model parameters, and calculating water resources-ecological environment-economic society coordination indicator values; and reducing dimensionality of the water resources-ecological environment-economic society coordination indicators and calculating corresponding indicator values, constructing regulation schemes, and screening an optimal scheme.

### CROSS-REFERENCE TO RELATED APPLICATIONS

This application claims priority to Chinese Patent Application No. 202411487681.9, filed on Oct. 24, 2024, the contents of which are hereby incorporated by reference.

### TECHNICAL FIELD

The present disclosure relates to a method for coordinated optimization of water resources, ecological environment, and socioeconomic system in a water network system.

### BACKGROUND

A water network system is a comprehensive system based on natural rivers and lakes, with water diversion and drainage projects as channels, water transfer projects as nodes, and intelligent regulation as the means, integrating functions such as optimal allocation of water resources, basin flood control and disaster reduction, and protection of water ecosystems. The water network system is an effective measure to address the uneven spatial distribution of water resources, improve the water resources rate in water-receiving areas, alleviate the contradiction between water supply and demand in water-scarce areas, and achieve rational allocation of water resources, and also an important approach to promote economic development and comprehensive development and utilization of water resources in water-scarce areas.

The water resources-ecological environment-economic society coordination is the primary goal in the construction, management, and operation of water network systems. However, the relationships among the elements constraining the factors of water network system water resources-ecological environment-economic society coordination are complex. Current research on water network subsystems and pairwise relationships is deepening, but the causal chains for water resources, ecological environment, and economic society in water network systems remain unclear, with direct and indirect influences intertwined. This makes it difficult to conduct comprehensive evaluations of water resources, ecological environment, and economic society. Moreover, mature multi-element coordination technologies for the entire water network system are lacking, and the feedback processes among water balance elements have not been fully analyzed from the perspective of the entire water network system to propose schemes for water resources-ecological environment-economic society coordination.

The present disclosure proposes a method for coordinated optimization of water resources, ecological environment, and socioeconomic system in a water network system to solve the aforementioned problems, improve the collaborative operation efficiency of hydraulic models, achieve comprehensive simulation of hydraulic systems, enhance the intelligent level of water network scheduling, realize deep interaction and integration of physical and digital water networks, promote the gradual development of various hydraulic projects from points to networks and from decentralization to systematization, and comprehensively improve the systematic, comprehensive, and resilient nature of water networks.

### SUMMARY

Objective of the present disclosure is to provide a method for coordinated optimization of water resources, ecological environment, and socioeconomic system in a water network system to solve the aforementioned problems in the prior art.

The method for coordinated optimization of water resources, ecological environment, and socioeconomic system in the water network system includes the following steps:
step S1, collecting historical rainfall, historical evapotranspiration and historical water resources quantity data of a study area, fitting marginal distributions of rainfall and evapotranspiration, constructing a joint distribution of the rainfall and the evapotranspiration, processing the collected rainfall and evapotranspiration data by fitting them to respective statistical distributions, constructing a joint probability distribution model and generate a plurality of synthetic hydrological scenarios, each scenario representing a potential variation of rainfall and evapotranspiration and inputting into a pre-built machine learning model to obtain water resources quantities corresponding to the massive scenarios;
step S2, collecting historical population and historical gross domestic product (GDP) data of the study area, constructing an economic society scale prediction model, using a rolling prediction method to obtain population prediction values and GDP prediction values, and combining to obtain economic society scale prediction samples;
step S3, inputting massive scenario samples into a pre-built multi-objective optimization model to obtain water resources-ecological environment-economic society coordination indicators, constructing a system dynamics model and calibrating model parameters, randomly combining the water resources quantities corresponding to the massive scenarios with the economic society scale prediction samples to obtain the massive scenario samples, and sequentially inputting into the system dynamics model to obtain water resources-ecological environment-economic society coordination indicator values corresponding to the massive scenario samples; and
step S4, reducing dimensionality of the water resources-ecological environment-economic society coordination indicators by using a maximum entropy projection pursuit method to obtain comprehensive coordination indicators and calculate corresponding comprehensive coordination indicator values, constructing regulation schemes, calculating transition degrees between the comprehensive coordination indicator values under different regulation schemes for each of the scenario samples, and screening to obtain an optimal scheme for the water resources-ecological environment-economic society coordination in the water network system.

According to one aspect of the present disclosure, the step S1 further includes:
step S11, collecting the historical rainfall, historical evapotranspiration, and historical water resources quantity data of the study area, constructing a machine learning model, and optimizing hyperparameters of the model based on the historical rainfall, historical evapotranspiration, and historical water resources quantity data;
step S12, fitting the marginal distributions of the rainfall and the evapotranspiration, constructing the joint distribution of the rainfall and the evapotranspiration, and randomly sampling to generate the massive scenarios; and
step S13, inputting the massive scenarios into the machine learning model after optimization to obtain the water resources quantities corresponding to the massive scenarios.

According to one aspect of the present disclosure, the step S11 further includes:
step S11a, collecting the historical rainfall, historical evapotranspiration and historical water resources quantity data of the study area, and dividing the data into a training set, a validation set, and a test set according to a ratio of 80/10/10;
step S11b, constructing a gradient boosting tree machine learning model, and training the machine learning model using the training set; and
step S11c, optimizing the hyperparameters of the machine learning model using a Bayesian optimization method, evaluating the model after hyperparameter optimization using the test set, and validating using the validation set.

According to one aspect of the present disclosure, the step S2 further includes:
step S21, constructing an economic society scale prediction model based on the machine learning model, collecting the historical population and historical GDP data of the study area, and calibrating parameters of the economic society scale prediction model based on the historical population and historical GDP data; and
step S22, using the rolling prediction method to obtain m population prediction values and n GDP prediction values, and combining to obtain m×n economic society scale prediction samples, where m and n are positive integers.

According to one aspect of the present disclosure, the step S22 further includes:
step S22a, using first four-fifths of the historical population and historical GDP data of the study area as a prediction set and remaining one-fifth as the validation set;
step S22b, inputting the prediction set into the economic society scale prediction model, using a moving average method to shift backward, and obtaining prediction values for the remaining one-fifth;
step S22c, comparing the prediction values for the remaining one-fifth with the validation set and optimizing the economic society scale prediction model; and
step S22d, inputting the historical population and historical GDP data of the study area into the economic society scale prediction model after optimization to obtain the m population prediction values and the n GDP prediction values, and combining to obtain the m×n economic society scale prediction samples.

According to one aspect of the present disclosure, the step S3 further includes:
step S31, constructing a multi-objective optimization model with an objective function of maximizing a degree of the water resources-ecological environment-economic society coordination;
step S32, inputting the massive scenario samples into the multi-objective optimization model to obtain the water resources-ecological environment-economic society coordination indicators in the water network system corresponding to the scenario samples;
step S33, collecting data of the water resources quantities, economic society, and ecological environment of the study area, constructing the system dynamics model based on relationships among the water resources quantities, the economic society, and the ecological environment, and calibrating parameters of the system dynamics model based on the data of the water resources quantities, the economic society, and the ecological environment of the study area;
step S34, extracting the water resources quantities corresponding to the massive scenarios and m×n economic society scale prediction samples, randomly combining the two to obtain the massive scenario samples; and
step S35, sequentially inputting the massive scenario samples into the system dynamics model to obtain the water resources-ecological environment-economic society coordination indicator values corresponding to the massive scenario samples.

According to one aspect of the present disclosure, the step S33 further includes:
step S33a, determining system elements based on the relationships among the water resources quantities, the economic society, and the ecological environment, dividing into three categories: water system connectivity, natural functions, and social functions;
step S33b, based on the three categories of system elements: the water system connectivity, the natural functions, and the social functions, constructing multiple system causal loops, including m positive feedback loops and n negative feedback loops, and constructing a system causal loop diagram, where m and n are positive integers;
step S33c, determining levels and rates based on the system causal loop diagram to obtain three subsystems of the water system connectivity, the natural functions, and the social functions, and merging the three subsystems to construct the system dynamics model; and
step S33d, calibrating the parameters of the system dynamics model using a sensitivity analysis method and historical validation based on the data of the water resources quantities, the economic society, and the ecological environment of the study area.

According to one aspect of the present disclosure, the step S4 further includes:
step S41, using the maximum entropy projection pursuit method to reduce the dimensionality of the water resources-ecological environment-economic society coordination indicators and obtain the comprehensive coordination indicators;
step S42, calculating respectively to obtain the comprehensive coordination indicator values corresponding to the massive scenario samples based on the water resources-ecological environment-economic society coordination indicator values corresponding to the massive scenario samples; and
step S43, constructing the regulation schemes, calculating the transition degrees between the comprehensive coordination indicator values under different regulation schemes for each of the scenario samples, selecting a regulation scheme with a highest transition degree as a most improved regulation scheme, namely, the optimal scheme for the water resources-ecological environment-economic society coordination in the water network system corresponding to the scenario samples.

According to one aspect of the present disclosure, the step S41 further includes:
step S41a, constructing a projection function;
step S41b, using entropy of projection values as a projection indicator function, and using the projection indicator function to measure information content of the projection values; and
step S41c, using a maximum entropy method to determine an optimal projection direction, and constructing an optimization model;
step S41d, inputting data of the water resources-ecological environment-economic society coordination indicators into the optimization model, and calculating to obtain one-dimensional projection vectors, namely, the comprehensive coordination indicators after dimensionality reduction.

According to one aspect of the present disclosure, the step S43 further includes:
step S43a, sequentially inputting the massive scenario samples into the multi-objective optimization model, setting A regulation measures, and setting B different regulation levels for each of the regulation measures to obtain A×B regulation schemes, where A and B are integers greater than 2;
step S43b, sequentially modifying parameters and boundary conditions of the multi-objective optimization model based on the A×B regulation schemes, solving the model to obtain the comprehensive coordination indicator values corresponding to each of the regulation schemes for each of the scenario samples; and
step S43c, using Markov one-step transition probability to sequentially calculate the transition degrees between original comprehensive coordination indicator values of each of the scenario samples and the comprehensive coordination indicator values after regulation under all the regulation schemes, selecting the regulation scheme with the highest transition degree as the most improved regulation scheme, namely, the optimal scheme for the water resources-ecological environment-economic society coordination in the water network system corresponding to the scenario samples.

Beneficial effects: by adopting the method for the water resources-ecological environment-economic society coordination in the water network system, the collaborative operation efficiency of hydraulic models is improved, comprehensive simulation of hydraulic systems is achieved, the intelligent level of water network scheduling is enhanced, deep interaction and integration of physical and digital water networks are realized, the gradual development of various hydraulic projects from points to networks and from decentralization to systematization is promoted, and the systematic, comprehensive, and resilient nature of water networks is comprehensively improved.

### DETAILED DESCRIPTION OF THE EMBODIMENTS

According to one aspect of the present disclosure, a method for water resources-ecological environment-economic society coordination in a water network system is provided, including the following steps:
step S1, collecting rainfall, evapotranspiration and water resources quantity data of the study area, fitting the marginal distributions of rainfall and evapotranspiration, constructing a joint distribution of the two, randomly sampling to obtain massive scenarios and inputting into a pre-built machine learning model to obtain water resources quantities corresponding to the massive scenarios;
step S2, collecting population and gross domestic product (GDP) data of the study area, constructing an economic society scale prediction model, using a rolling prediction method to obtain population prediction values and GDP prediction values, and combining to obtain economic society scale prediction samples;
step S3, inputting the massive scenario samples into a pre-built multi-objective optimization model to obtain water resources-ecological environment-economic society coordination indicators, constructing a system dynamics model and calibrating model parameters, randomly combining the water resources quantities corresponding to the massive scenarios with the economic society scale prediction samples to obtain massive scenario samples, and sequentially inputting the massive scenario samples into the system dynamics model to obtain water resources-ecological environment-economic society coordination indicator values corresponding to the massive scenario samples; and
step S4, reducing the dimensionality of the water resources-ecological environment-economic society coordination indicators by using the maximum entropy projection pursuit method to obtain comprehensive coordination indicators and calculate corresponding comprehensive coordination indicator values, constructing regulation schemes, calculating transition degrees between the comprehensive coordination indicator values under different regulation schemes for each of the scenario samples, and screening to obtain an optimal scheme for the water resources-ecological environment-economic society coordination in the water network system.

The water resources-ecological environment-economic society coordination is the primary goal in the construction, management, and operation of water network systems. To improve the collaborative operation efficiency of hydraulic models, achieve comprehensive simulation of hydraulic systems, and enhance the intelligent level of water network scheduling, the present disclosure constructs causal chains for water resources, ecological environment, and economic society in water network systems to clarify the relationships among the elements. First, there is a need to collect various data on water resources quantity, economic society, and ecological environment. According to the present disclosure, the multi-source hydrological, meteorological, and environmental data are first collected historically and in a real time. The real time rainfall data is obtained using a combination of small-scale automated rain gauges installed at the rain monitoring stations of study area. The real time evapotranspiration data is collected from the soil moisture sensors, solar radiation and wind speed sensors, and remote sensing data which are installed at the rain monitoring stations. The real time water resource quantity data is measured using ultrasonic or radar flow meters installed in rivers and irrigation canals, water level sensors in reservoirs and lakes, and groundwater monitoring wells equipped with pressure sensors. These sensors record hydrological parameters at regular intervals, transmitting data via wireless communication modules to a centralized platform.

A large number of simulated scenario data for machine learning model training and calculation are obtained by fitting the marginal distributions of rainfall and evapotranspiration, constructing their joint distribution and randomly sampling. After training the machine learning model, the model is used for calculating to obtain the water resources quantities.

Secondly, the historical population and historical GDP data of the study area are collected, and the population and GDP are predicted by constructing an economic society scale prediction model, and based on the correspondence between historical population and GDP data, the relationship curve between the historical population data and GDP data is predicted to predict the future population and GDP data respectively, and the economic society scale prediction samples, namely economic society data, are obtained based on the cross combination of the predicted data.

Then, based on the calculated water resources quantities and economic society data, along with the ecological environment data of the study area, a system dynamics model of the study area is constructed to obtain the structural functions and connections of the subsystems within the study area. Based on this, coordinated optimization of water resources, ecological environment, and economic society in the water network system of the study area is performed.

According to one aspect of the present disclosure, the step S1 further includes:
step S11, collecting and storing the multi-source historical information in a standardized format in a plurality of network-based non-transitory storage devices having a collection of historical rainfall, historical evapotranspiration, and historical water resources quantity data of the study area, and providing the remote access to users over a network so any one of the user can update the information about the historical rainfall, historical evapotranspiration, and historical water resources quantity data in real time through a graphical user interface, wherein one of the users provide the updated information in a non-standardized format followed by converting the non-standardized updated information into the standardized format;
step S12, fitting the marginal distributions of rainfall and evapotranspiration, constructing a joint distribution of the rainfall and evapotranspiration, and randomly sampling to generate the massive scenarios; and
step S13, inputting the massive scenarios into the machine learning model after optimization to obtain water resources quantities corresponding to the massive scenarios.

According to one aspect of the present disclosure, the step S11 further includes:
step S11a, collecting historical rainfall, historical evapotranspiration and historical water resources quantity data of the study area, and dividing the data into training set, validation set, and test set according to a ratio of 80/10/10;
step S11b, constructing a gradient boosting tree machine learning model, and training the machine learning model using the training set; and
step S11c, optimizing the hyperparameters of the machine learning model using the Bayesian optimization method, evaluating the model after hyperparameter optimization using the test set, and validating using the validation set.

According to one aspect of the present disclosure, the step S2 further includes:
step S21, constructing an economic society scale prediction model based on the machine learning model, collecting historical population and historical GDP data of the study area, and calibrating the parameters of the economic society scale prediction model based on the historical population and historical GDP data; and
step S22, using the rolling prediction method to obtain m population prediction values and n GDP prediction values, and combining to obtain m×n economic society scale prediction samples, where m and n are positive integers.

According to one aspect of the present disclosure, the step S22 further includes:
step S22a, using the first four-fifths of the historical population and historical GDP data of the study area as the prediction set and the remaining one-fifth as the validation set;
step S22b, inputting the prediction set into the economic society scale prediction model, using the moving average method to shift backward, and obtaining prediction values for the remaining one-fifth;
step S22c, comparing the prediction values for the remaining one-fifth with the validation set and optimizing the economic society scale prediction model; and
step S22d, inputting the historical population and historical GDP data of the study area into the economic society scale prediction model after optimization to obtain m population prediction values and n GDP prediction values, and combining to obtain m×n economic society scale prediction samples.

The rolling prediction method is a method used to forecast time series data, commonly applied in sales forecasting or inventory management. This method is based on the concept of rolling, namely, the data sequence is imagined as a rolling wheel. Each time the data is observed, one time window is shifted forward, and the data within this time window is used for prediction. Specifically as follows.

An appropriate time window size is selected, i.e., the number of data points included each time the wheel is rolled forward;
the time series data is decomposed into multiple time windows, one time window is shifted forward each time for prediction, and average, moving average, and exponential smoothing method are used to predict the values within the next time window; and
historical data is used to evaluate the accuracy of the rolling prediction method.

In this embodiment, due to the fact that the economic society is different from the natural law and is growing steadily, the distribution of the economic society may not be obtained by fitting method. In this embodiment, the rolling prediction method is used to obtain the distribution of predicted values for economic society scale. In a specific embodiment, the steps are as follows:
historical population and historical GDP data of the study area of the past 30 years are collected;
the historical population and historical GDP data of the first 24 years are used as the test set and the historical population and historical GDP data of the next 6 years are used as the validation set;
based on the relationships between historical population and historical GDP in the test set, the relationship curve of the two is obtained; based on the development laws of economic society, the relationship curve is shifted backward to obtain the predicted data of historical population and historical GDP of the next 6 years;
the validation set is compared with the predicted data and the relationship curve is modified to obtain the economic society scale prediction model after optimization; and
the historical population and historical GDP data of the study area of the past 30 years are input into the economic society scale prediction model after optimization to obtain several population prediction values and several GDP prediction values, and the two are combined to obtain an economic society scale prediction sample set.

According to one aspect of the present disclosure, the step S3 further includes:
step S31, constructing a multi-objective optimization model with an objective function of maximizing a degree of the water resources-ecological environment-economic society coordination;
step S32, inputting the massive scenario samples into the multi-objective optimization model to obtain the water resources-ecological environment-economic society coordination indicators in the water network system corresponding to the scenario samples; and
step S33, collecting data of the water resources quantities, economic society, and ecological environment of the study area, constructing the system dynamics model based on the relationships among the water resources quantities, the economic society, and the ecological environment, and calibrating parameters of the system dynamics model based on the data of the water resources quantities, the economic society, and the ecological environment of the study area.

System dynamics is a method that combines qualitative and quantitative analysis with system analysis, which is suitable for long-term dynamic trend research and may comprehensively simulate and analyze the internal relationships of various complex systems and long-term dynamics under different decisions. In this embodiment, since river and lake water system connectivity is a complex feedback system involving society, ecology, and resources, the interactions among water system connectivity, social functions, and natural functions may be obtained through quantitative analysis and simulation of system dynamics, which facilitates simulation and analysis of the evolution patterns of major driving factors. Therefore, in this embodiment, a system dynamics model is constructed to depict the water network system within the study area.
Step S34, extracting the water resources quantities corresponding to the massive scenarios and m×n economic society scale prediction samples, randomly combining the two to obtain the massive scenario samples; and
Step S35, sequentially inputting the massive scenario samples into the system dynamics model to obtain the water resources-ecological environment-economic society coordination indicator values corresponding to the massive scenario samples.

According to one aspect of the present disclosure, the step S33 further includes:
step S33a, determining system elements based on the relationships among water resources quantity, economic society, and ecological environment, dividing into three categories: water system connectivity, natural functions, and social functions;
step S33b, based on the three categories of system elements: water system connectivity, natural functions, and social functions, constructing multiple system causal loops, including m positive feedback loops and n negative feedback loops, and constructing a system causal loop diagram, where m and n are positive integers;
step S33c, determining the levels and rates based on the system causal loop diagram to obtain three subsystems of water system connectivity, natural functions, and social functions, and merging the three subsystems to construct the system dynamics model; and
step S33d, calibrating the parameters of the system dynamics model using a sensitivity analysis method and historical validation based on the data of water resources quantities, economic society, and ecological environment of the study area.

System dynamics describes the dependency relationship of the rate of change of each state variable of the system on each state variable or specific input. The principles of system dynamics modeling are that:
the system may fully describe the structure of the system and behaviors at different times using state variables;
each feedback loop in the model should contain at least one state variable;
the principle of material conservation; and
any state variable in the system indirectly affects another state variable.

The specific steps for system dynamics model modeling are as follows:
the simulation objectives of the system are determined, the system boundaries are defined, and the problems the system aims to solve are determined;
the relevant factors of the system and the interrelationships of the factors are determined, the causality diagram is constructed and relationships are fed back, the mutual constraints among feedback loops are observed, and policies for controlling the system are formulated;
system flow diagrams and structural equations, including level equations, rate equations, and auxiliary variable equations, are constructed to obtain the system dynamics model;
initial value assignment and simulation are performed on the equations in the model, the initial values of parameters and variable values are input into the structural equations for simulation to obtain predicted values for each variable; and
the system model is revised based on the simulation results, including model operating parameters, system structure, and boundaries.

According to one aspect of the present disclosure, the step S4 further includes:
step S41, using the maximum entropy projection pursuit method to reduce the dimensionality of the water resources-ecological environment-economic society coordination indicators and obtain the comprehensive coordination indicators;
step S42, calculating respectively to obtain the comprehensive coordination indicator values corresponding to the massive scenario samples based on the water resources-ecological environment-economic society coordination indicator values corresponding to the massive scenario samples; and
step S43, constructing regulation schemes, calculating transition degrees between the comprehensive coordination indicator values under different regulation schemes for each of the scenario samples, selecting the regulation scheme with the highest transition degree as the most improved regulation scheme, namely, the optimal scheme for the water resources-ecological environment-economic society coordination in the water network system corresponding to the scenario samples.

According to one aspect of the present disclosure, the step S41 further includes:
step S41a, constructing a projection function;
step S41b, using the entropy of the projection values as the projection indicator function, and using the projection indicator function to measure the information content of the projection values;
step S41c, using the maximum entropy method to determine the optimal projection direction, and constructing an optimization model; and
step S41d, inputting the water resources-ecological environment-economic society coordination indicator data into the optimization model, and calculating to obtain one-dimensional projection vectors, namely, the comprehensive coordination indicators after dimensionality reduction.

The projection pursuit method projects high-dimensional data into a low-dimensional space, and through numerical calculation, maximizes the indicators reflecting the clustering degree of the data, thereby finding the optimal projection to reveal the structural features of the data. In a specific embodiment, the method is as follows.

The standardized p-dimensional data containing n samples are reduced to one-dimensional projection values.

A projection indicator function is constructed. In the projection pursuit method, the projection indicator function is constructed as the multiplication of the intra-class density and inter-class distance of the projection values, with the aim of revealing the spatial distribution structure characteristics of the original high-dimensional data as much as possible. In this embodiment, to extract as much information as possible from high-dimensional risk factors, solve the problem of dimensional disasters, and preserve as much original information as possible, the entropy of the projection values is used as the projection indicator function to measure the information content of the projection values.

The maximum entropy method is used to select solutions and extract as much information as possible from the known data while making minimal assumptions about the unknown parts. When the information content of the projection values is maximized, the optimal parameters are obtained.

The obtained optimal projection direction is substituted into the projection value calculation formula to obtain the projection vector.

By using the projection pursuit method to reduce the dimensionality of multiple coordination equilibrium indicators into a single comprehensive coordination equilibrium indicator, the subsequent judgment of equilibrium states and screening of regulation schemes become more intuitive and straightforward, while also reducing computational load. Therefore, in this embodiment, the maximum entropy projection pursuit method is used to reduce the dimensionality of the water resources-ecological environment-economic society coordination equilibrium indicators and obtain a comprehensive coordination equilibrium indicator.

According to one aspect of the present disclosure, the step S43 further includes:
step S43a, sequentially inputting the massive scenario samples into the multi-objective optimization model, setting A regulation measures, and setting B different regulation levels for each of the regulation measures to obtain A×B regulation schemes, where A and B are integers greater than 2;
step S43b, sequentially modifying the parameters and boundary conditions of the multi-objective optimization model based on the A×B regulation schemes, solving the model to obtain the comprehensive coordination indicator values corresponding to each of the regulation schemes for each of the scenario samples; and
step S43c, using the Markov one-step transition probability to sequentially calculate the transition degrees between the original comprehensive coordination indicator values of each of the scenario samples and the comprehensive coordination indicator values after regulation under all the regulation schemes, selecting the regulation scheme with the highest transition degree as the most improved regulation scheme, namely, the optimal scheme for the water resources-ecological environment-economic society coordination in the water network system corresponding to the scenario samples.

Automatically generating a message containing the updated information about the optimal scheme for the water resources-ecological environment-economic society coordination in the water network system by the content server whenever updated information has been stored;

Transmitting the message to all of the users over the electronic devices in a real time, so that each user has immediate access to up-to-date information.

The preferred embodiments of the present disclosure have been described in detail above. However, the present disclosure is not limited to the specific details in the aforementioned embodiments. Within the technical scope of the present disclosure, various equivalent modifications may be made to the technical solutions of the present disclosure, and all such modifications fall within the protection scope of the present disclosure.

What is claimed is:

1. A method for water resources-ecological environment-economic society coordination in a water network system, comprising following steps:
step S1, collecting historical rainfall, historical evapotranspiration and historical water resources quantity data of a study area, fitting marginal distributions of rainfall and evapotranspiration, constructing a joint distribution of the rainfall and the evapotranspiration, randomly sampling to obtain massive scenarios and inputting into a pre-built machine learning model to obtain water resources quantities corresponding to the massive scenarios;
step S2, collecting historical population and historical gross domestic product (GDP) data of the study area, constructing an economic society scale prediction model, using a rolling prediction method to obtain population prediction values and GDP prediction values, and combining to obtain economic society scale prediction samples;
step S3, inputting massive scenario samples into a pre-built multi-objective optimization model to obtain water resources-ecological environment-economic society coordination indicators, constructing a system dynamics model and calibrating model parameters, randomly combining the water resources quantities corresponding to the massive scenarios with the economic society scale prediction samples to obtain the massive scenario samples, and sequentially inputting into the system dynamics model to obtain water resources-ecological environment-economic society coordination indicator values corresponding to the massive scenario samples; and
step S4, reducing dimensionality of the water resources-ecological environment-economic society coordination indicators by using a maximum entropy projection pursuit method to obtain comprehensive coordination indicators and calculate corresponding comprehensive coordination indicator values, constructing regulation schemes, calculating transition degrees between the comprehensive coordination indicator values under different regulation schemes for each of the scenario samples, and screening to obtain an optimal scheme for the water resources-ecological environment-economic society coordination in the water network system,
wherein the step S3 further comprises:
step S31, constructing a multi-objective optimization model with an objective function of maximizing a degree of the water resources-ecological environment-economic society coordination;
step S32, inputting the massive scenario samples into the multi-objective optimization model to obtain the water resources-ecological environment-economic society coordination indicators in the water network system corresponding to the scenario samples;
step S33, collecting data of the water resources quantities, economic society, and ecological environment of the study area, constructing the system dynamics model based on relationships among the water resources quantities, the economic society, and the ecological environment, and calibrating parameters of the system dynamics model based on the data of the water resources quantities, the economic society, and the ecological environment of the study area;
step S34, extracting the water resources quantities corresponding to the massive scenarios and m×n economic society scale prediction samples, randomly combining the two to obtain the massive scenario samples; and
step S35, sequentially inputting the massive scenario samples into the system dynamics model to obtain the water resources-ecological environment-economic society coordination indicator values corresponding to the massive scenario samples,
wherein the step S33 further comprises:
step S33a, determining system elements based on the relationships among the water resources quantities, the economic society, and the ecological environment, and dividing into three categories: water system connectivity, natural functions, and social functions;
step S33b, based on the three categories of system elements: the water system connectivity, the natural functions, and the social functions, constructing multiple system causal loops, comprising m positive feedback loops and n negative feedback loops, and constructing a system causal loop diagram, wherein m and n are positive integers;
step S33c, determining levels and rates based on the system causal loop diagram to obtain three subsystems of the water system connectivity, the natural functions, and the social functions, and merging the three subsystems to construct the system dynamics model; and
step S33d, calibrating the parameters of the system dynamics model using a sensitivity analysis method and historical validation based on the data of the water resources quantities, the economic society, and the ecological environment of the study area,
wherein the step S4 further comprises:
step S41, using the maximum entropy projection pursuit method to reduce the dimensionality of the water resources-ecological environment-economic society coordination indicators and obtain the comprehensive coordination indicators;
step S42, calculating respectively to obtain the comprehensive coordination indicator values corresponding to the massive scenario samples based on the water resources-ecological environment-economic society coordination indicator values corresponding to the massive scenario samples; and
step S43, constructing the regulation schemes, calculating the transition degrees between the comprehensive coordination indicator values under different regulation schemes for each of the scenario samples, and selecting a regulation scheme with a highest transition degree as a most improved regulation scheme, namely, the optimal scheme for the water resources-ecological environment-economic society coordination in the water network system corresponding to the scenario samples,
wherein the step S41 further comprises:
step S41a, constructing a projection function;
step S41b, using entropy of projection values as a projection indicator function, and using the projection indicator function to measure information content of the projection values; and
step S41c, using a maximum entropy method to determine an optimal projection direction, and constructing an optimization model;
step S41d, inputting data of the water resources-ecological environment-economic society coordination indicators into the optimization model, and calculating to obtain one-dimensional projection vectors, namely, the comprehensive coordination indicators after dimensionality reduction,
wherein the step S43 further comprises:
step S43a, sequentially inputting the massive scenario samples into the multi-objective optimization model, setting A regulation measures, and setting B different regulation levels for each of the regulation measures to obtain A×B regulation schemes, wherein A and B are integers greater than 2;
step S43b, sequentially modifying parameters and boundary conditions of the multi-objective optimization model based on the A×B regulation schemes, and solving the model to obtain the comprehensive coordination indicator values corresponding to each of the regulation schemes for each of the scenario samples; and
step S43c, using Markov one-step transition probability to sequentially calculate the transition degrees between original comprehensive coordination indicator values of each of the scenario samples and the comprehensive coordination indicator values after regulation under all the regulation schemes, and selecting the regulation scheme with the highest transition degree as the most improved regulation scheme, namely, the optimal scheme for the water resources-ecological environment-economic society coordination in the water network system corresponding to the scenario samples.

2. The method for the water resources-ecological environment-economic society coordination in the water network system according to claim 1, wherein the step S1 further comprises:
step S11, collecting the historical rainfall, historical evapotranspiration, and historical water resources quantity data of the study area, constructing a machine learning model, and optimizing hyperparameters of the model based on the historical rainfall, historical evapotranspiration, and historical water resources quantity data;
step S12, fitting the marginal distributions of the rainfall and the evapotranspiration, constructing the joint distribution of the rainfall and the evapotranspiration, and randomly sampling to generate the massive scenarios; and
step S13, inputting the massive scenarios into the machine learning model after optimization to obtain the water resources quantities corresponding to the massive scenarios.

3. The method for the water resources-ecological environment-economic society coordination in the water network system according to claim 2, wherein the step S11 further comprises:
step S11a, collecting the historical rainfall, historical evapotranspiration and historical water resources quantity data of the study area, and dividing the data into a training set, a validation set, and a test set according to a ratio of 80/10/10;
step S11b, constructing a gradient boosting tree machine learning model, and training the machine learning model using the training set; and
step S11c, optimizing the hyperparameters of the machine learning model using a Bayesian optimization method, evaluating the model after hyperparameter optimization using the test set, and validating using the validation set.

4. The method for the water resources-ecological environment-economic society coordination in the water network system according to claim 1, wherein the step S2 further comprises:
step S21, constructing an economic society scale prediction model based on the machine learning model, collecting the historical population and historical GDP data of the study area, and calibrating parameters of the economic society scale prediction model based on the historical population and historical GDP data; and
step S22, using the rolling prediction method to obtain m population prediction values and n GDP prediction values, and combining to obtain the m×n economic society scale prediction samples, wherein m and n are positive integers.

5. The method for the water resources-ecological environment-economic society coordination in the water network system according to claim 4, wherein the step S22 further comprises:
step S22a, using first four-fifths of the historical population and historical GDP data of the study area as a prediction set and remaining one-fifth as the validation set;
step S22b, inputting the prediction set into the economic society scale prediction model, using a moving average method to shift backward, and obtaining prediction values for the remaining one-fifth;
step S22c, comparing the prediction values for the remaining one-fifth with the validation set and optimizing the economic society scale prediction model; and
step S22d, inputting the historical population and historical GDP data of the study area into the economic society scale prediction model after optimization to obtain the m population prediction values and the n GDP prediction values, and combining to obtain the m×n economic society scale prediction samples.
